(19) United States
(12) Patent Application Publication
(10) Pub. No.: US 2012/0036569 A1
(43) Pub. Date: Feb. 9, 2012

(54) SECURING PORTABLE EXECUTABLE MODULES

(76) Inventors: Andrew Cottrell, San Jose, CA (US); Juan Gamez, Foster City, CA (US)

(21) Appl. No.: 13/277,217

(22) Filed: Oct. 20, 2011

Related U.S. Application Data
(63) Continuation-in-part of application No. 12/754,086, filed on Apr. 5, 2010.

(51) Int. Cl. H04L 9/32; G06F 21/00

(52) U.S. Cl. 726/7; 726/16

(57) ABSTRACT

An import address table (IAT) and dynamic linked libraries (DLLs) security mender process is configured to store nominal IAT table entries and in-process binary images, from either a priori data and/or from computed values. Particular IAT table entries and in-process binary images are fetched for comparison with expected values. These particular IAT table entries and/or in-process binary images are then overwritten with nominal values for the IAT table entries and in-process binary images. The IAT-DLL security mender runs in parallel with the operating system and has access to its IAT and inline code in system memory.

### COPENDING APPLICATION

This Application is a Continuation-in-Part of U.S. patent application, Ser. No. 12/754,086, filed Apr. 5, 2010, and titled, USER AUTHENTICATION SYSTEM.

### BACKGROUND OF THE INVENTION

1. Field of the Invention

The present invention relates to computer operating systems, and more particularly to securing portable executable modules for better handling of user credentials.

2. Description of Related Art

A chain is only as strong as its weakest link. This rings true for secure networks as well. The weak link of concern here is the open system calls common in operating systems like MICROSOFT WINDOWS that are used to forward data from protected programs to subroutines and modules that forward sensitive user credentials to secure network connections.

MICROSOFT's Portable Executable (PE) format is a file format for executables, object code and dynamic link libraries (DLL's), used in 32-bit and 64-bit versions of Windows operating systems. Wikipedia, and see, Microsoft PE and COFF Specification. The PE format incorporates the information needed by the WINDOWS OS loader to manage wrapped executable code. Such includes dynamic library references for linking, API export and import tables, resource management data and thread-local storage (TLS) data. The PE format is used for EXE, DLL, SYS (device driver), and other file types on NT operating systems.

PE files have headers and sections for a dynamic linker to map files into memory. Executable images have several different regions, each requiring their own memory protection. So the start of each section must be aligned to a page boundary. E.g., the typical “.text” section which holds program code is mapped as execute/readonly. The typical “.data” section for global variables is mapped as no-execute/readwrite. But, these sections are not page aligned on disk. So, the dynamic linker has to map each section to memory individually and assign the correct permissions to the resulting regions, according to the instructions found in the headers.

An import address table (IAT) is used as a lookup table when applications need to call functions in other modules, like input/output. The IAT is, unfortunately, completely open. Any program wanting access can have it. For example, WindowsSCOPE by BlueRISC, Inc., (Amherst, Mass.) can be used to directly view the import and export address tables of any process or driver memory. Virtually every program takes advantage of calling functions from DLL's making import and export address tables an integral part of Windows. Its graphing tool can be used to see the transitions between process and drivers, and the DLL's that they use.

PE files are not position-independent code because they are compiled to a preferred base address, and all the addresses are fixed by a compiler/linker during compile-time. When a PE file cannot be loaded at its preferred address, the operating system can rebase it by recalculating every absolute address and modifying the code to use the new values. Base relocations are stored in a list and added, as needed, to an existing memory location. DLL's shipped by MICROSOFT have base addresses pre-computed so as not to overlap.

Compiled programs do not know the true run-time memory locations of the libraries they depend on at compile-time, so an indirect jump is required to be inserted in the IAT later. E.g., for application programming interface (API) calls that will be made during run-time. Microsoft WINDOWS even routinely patches these again during normal operation. A PE loader is a dynamic linker that load modules and joins them together during run-time, and it writes the actual addresses into the respective IAT slots. These then point to the memory locations of the corresponding library functions.

But malicious programs can come along at any time and rewrite these IAT entries such that malicious code will be surreptitiously executed instead. “Hooking” requires as little as exchanging a single pointer in the IAT, e.g., using an interlocked instruction. Such hooks need to be detected, and at least removed or overwritten to fix this weak link in overall security.

Another way a malicious program can be surreptitiously executed is to leave the IAT alone and simply insert a program jump or detour in the binary image of the function the calling user was trying to get to. See, “Detours: Binary Interception of Win32 Functions”, Proceedings of the 3rd USENIX Windows NT Symposium. Seattle, Wash., July 1999. So it would not be enough to simply re-patch the IAT because in the case of detours, the IAT is not tampered with, only consulted to see where the target called-function's binary image begins in program memory. Hooks like this in the functional modules also need to be detected, and at least removed or overwritten to fix this second weak link in overall security.

In WINDOWS API, DLL files are organized into sections, each with its own attributes, such as being writable or read-only, executable (for code) or non-executable (for data), etc. DLL code is usually shared among all the processes that use the DLL, they occupy a single place in physical memory, and do not take up space in the page file. DLL data sections are usually private, each process its own copy. Data sections can be shared, and allow inter-process communication. However, this creates a security vulnerability because the shared data can be corrupted by any one of the processes sharing it.

What is needed is a device to protect the IAT slots and ensure the intended modules can be relied upon to execute as expected. This is especially important when user credentials are being sent to remote, secure servers and other sensitive data is to be entrusted to the modules that are being employed.

### SUMMARY OF THE INVENTION

Briefly, a security embodiment of the present invention protects import address tables (IAT) and user functions in operating systems by routinely repairing IAT slots and user code and/or immediately before they are called on to handle a secure function like forwarding user credentials to a secure server. An IAT-DLL security mender process is configured to store nominal IAT table entries and in-process binary images, from either a priori data and/or from computed values. Particular IAT table entries and in-process binary images are fetched for comparison with expected values. These particular IAT table entries and/or in-process binary images are then overwritten with nominal values for the IAT table entries and in-process binary images. The IAT-DLL security mender runs in parallel with the operating system and has access to its IAT and inline code in system memory.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIGS. 1A-1D are functional block diagrams of a user authentication system embodiment of the present invention with a network server and a client for user authentication;

FIG. 2 is a functional block diagram of a trusted network library system embodiment of the present invention that is added to support the user authentication system of FIGS. 1A-1D; and

FIGS. 3A and 3B are functional block diagrams of a user authentication method embodiment of the present invention useful in the user authentication system of FIGS. 1A-1D. FIG. 3A represents the functioning of the method when a user registers the ID vault application program for the first time. FIG. 3B represents the functioning of the method when a user wants to be authenticated to the server;

FIG. 4 is a functional block diagram an IAT-DLL security mender process implemented within a computer platform and configured for execution in parallel with an operating system; and

FIG. 5 is a flowchart diagram of an IAT-DLL security mender process implemented as software and configured for execution by a computer platform and an operating system.

### DETAILED DESCRIPTION OF THE INVENTION

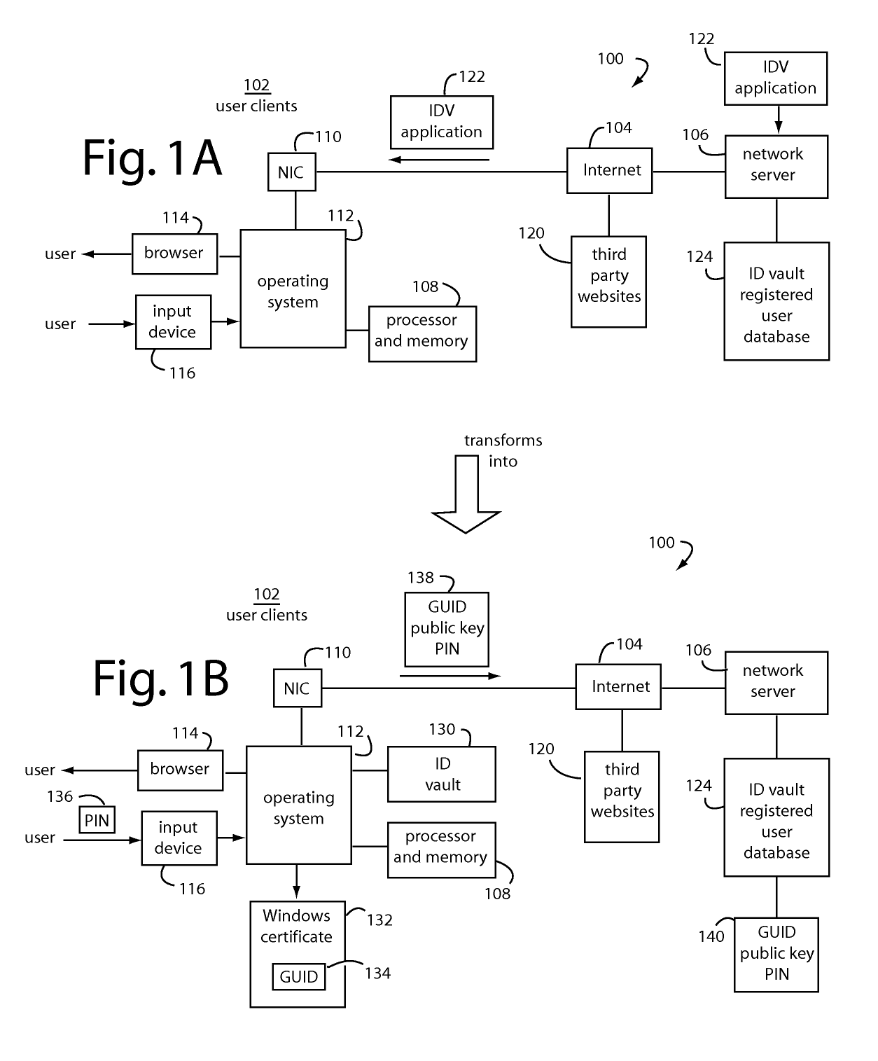

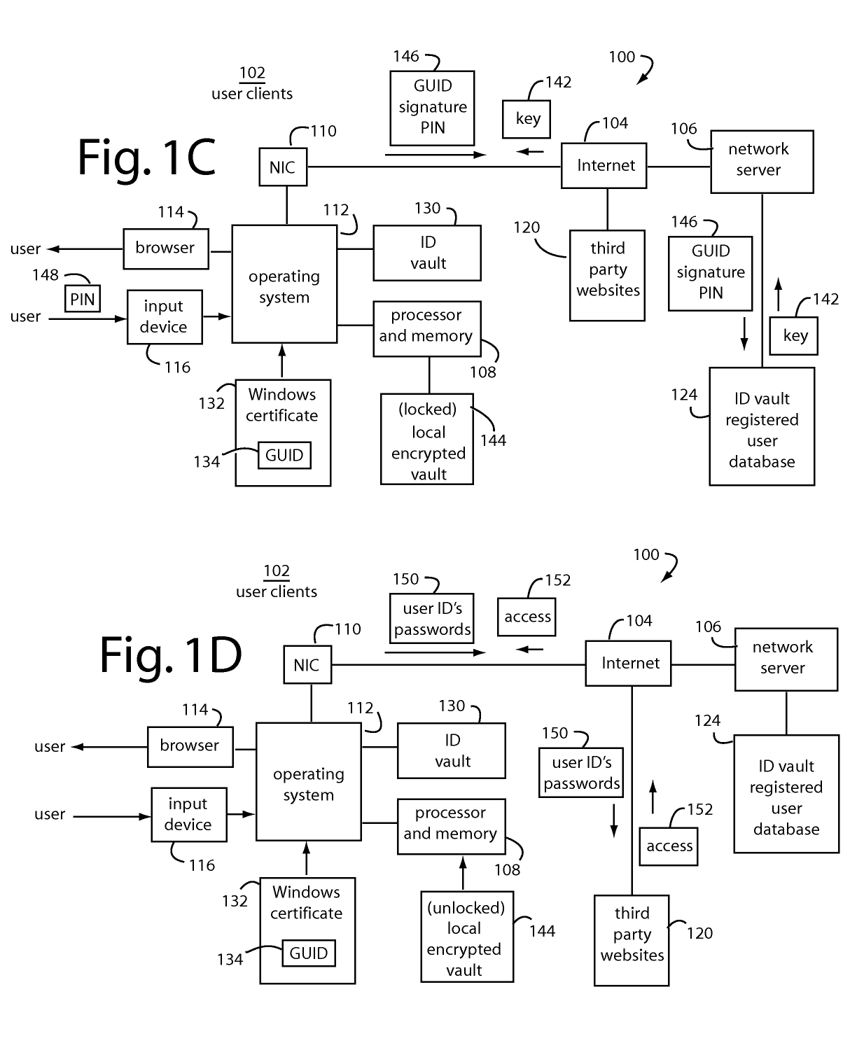

Embodiments of the present invention protect secure systems from malicious hooking of the import address table (IAT) and dynamic link libraries (DLL's) that can occur in standard operating systems like Microsoft WINDOWS. FIGS. 1A-1D, 2, 3A, and 3B illustrate the kind of systems that can benefit from such protection.

FIGS. 1A-1B represent a user authentication system, and is referred to herein by the general reference numeral 100. FIG. 1A represents an initial condition in which one of many user clients 102 has connected through the Internet 104 to a network server 106. The user clients 102 typically include a processor and memory 108, network interface controller (NIC) 110, an operating system 112 like WINDOWS, a browser 114 like INTERNET EXPLORER, and an input device 116 like a common keyboard and mouse. The browser 114 also allows the user clients 102 to visit third-party secure websites 120 that each require authentication from the user, e.g., a user ID and password.

Network server 106 can offer for download an ID vault (IDV) application program 122, and maintains a database 124 of registered IDV users. The IDV application program 122 can be sold, subscribed to, given away for free, offered as a prize or award, and/or provided on a disk or memory card.

FIG. 1B represents how user authentication system 100 is transformed by the installation of IDV application program 122 in user clients 102. An installation and registration process, when launched, builds an ID vault run-time client 130, a WINDOWS root certificate 132, and a globally unique identifier (GUID) 134. The WINDOWS root certificate 132 is created and signed for exclusive use by ID vault run-time client 130. There is no other root authority involved. The GUID 134 is a unique identifier earmarked exclusively for the particular installation of ID vault run-time client 130 on user client 102. When GUID 134 is created it is placed in WINDOWS root certificate 132. Network server 106 is called to create a PIN record and passes the GUID 134, the public key for WINDOWS root certificate 132, and a personal identification number (PIN) 136 provided by the user. These are forwarded in a message 138 to network server 106. The network server 106 creates a new user record 140 and stores it and others in user database 124. The particular user and their user client 102 are thereby registered.

FIG. 1C represents how the user authentication system 100 is transformed from that shown in FIG. 1B by the running of ID vault run-time client 130 in user client 102. When the user tries to open an account at a third-party website 120, a service in ID vault run-time client 130 is called to get a “protected” encryption key 142 needed to access a locked, local encrypted vault 144. That call passes a message 146 that includes a copy of GUID 134, a signature of GUID 134 using the private key for WINDOWS root certificate 132, and a freshly acquired PIN 148 (which is required to match the original PIN 136 used during registration for the user to be authenticated). Network server 106 then verifies that GUID 134 already exists in database 124, and if so, tests to see that the signature is correct using the public key previously supplied in new user record 140. It further tests to see that PIN 148 matches PIN 136 which was received previously in new user record 140. If the tests are successful, a “protected” encryption key 142 is sent to user client 102. Such “protected” encryption key 142 will expire after a limited time. But before it does expire, the user can automatically and transparently log-on to many secure third party websites 120 that it is registered for.

The “protected” encryption key 142 the server returns is not the actual decryption key needed to unlock the secure files. The receiving client uses its certificate (private key) to actually decrypt key 142 and get the actual symmetric key that was used to encrypt the vault. In other words, the “protected” encryption key the server sends needs further processing by the client and its certificate before the response can be used to access the vault. The certificate and the key returned by the server are therefore strongly bound.

FIG. 1D represents how the user authentication system 100 is transformed from that shown in FIG. 1C by the routine use of ID vault run-time client 130 in user client 102. After the “protected” encryption key 142 is received, the local encrypted vault 144 can be unlocked. Thereafter, as browser 114 navigates to third party websites 120, ID vault run-time client 130 recognizes that a user ID and password 150 are needed. The local encrypted vault 144 stores all the user ID's and passwords 150 that were collected in previous sessions to automatically log-on to corresponding third party websites 120. Once logged on, the user client is given an access response 152. If a token is needed from a fob, the token is read and entered by the user as usual at input device 116. ID vault run-time client 130 will automatically relock local encrypted vault 144 after a predetermined or programmable time set by the user.

GUID 134 is a randomly generated 128-bit integer represented by a 32-character hexadecimal character string. For example, “c12eb070-2be2-11df-8a39-0800200c9a66”. The odds are that such number will be unique for all practical purposes. A GUID can be assumed to never be generated twice by any computer. Microsoft Windows uses GUID's internally to identify classes in DLL files. A script can activate a specific class or object without having to know the name or location of the Dynamic Linked Library that includes it. ActiveX uses GUID's to uniquely identify controls being downloading and installed in a web browser. GUID's can be obtained with a random-number generator, or based on a time. GUID's can also include some parts based on the hardware environment, such as the MAC address of a network card.

Certificates, like WINDOWS root certificate 132, support authentication and encrypted exchange of information on open networks such as the Internet, extranets, and intranets. The public key infrastructure (PKI) is used to issue and manage the certificates. Each WINDOWS root certificate 132 is a digitally-signed statement that binds the value of a public key to the identity of the person, device, or service that holds the corresponding private key. With conventional certificates, host computers on the Internet can create trust in the certification authority (CA) that certifies individuals and resources that hold the private keys. Trust in the PKI here is based on WINDOWS root certificate 132. Such certificates are conventionally used in secure sockets layer (SSL) sessions, when installing software, and when receiving encrypted or digitally signed e-mail messages.

The Update Root Certificates feature in Windows Vista is designed to automatically check the list of trusted authorities on the Windows Update Web site when this check is needed by a user's application. Ordinarily, if an application is presented with a certificate issued by a certification authority in a PKI that is not directly trusted, the Update Root Certificates feature will contact the Windows Update Web site to see if Microsoft has added the certificate of the root CA to its list of trusted root certificates. If the CA has been added to the Microsoft list of trusted authorities, its certificate will automatically be added to the set of trusted root certificates on the user's computer.

When a certification authority is configured inside an organization, the certificates issued can specify the location for retrieval of more validation evidence. Such location can be a Web server or a directory within the organization.

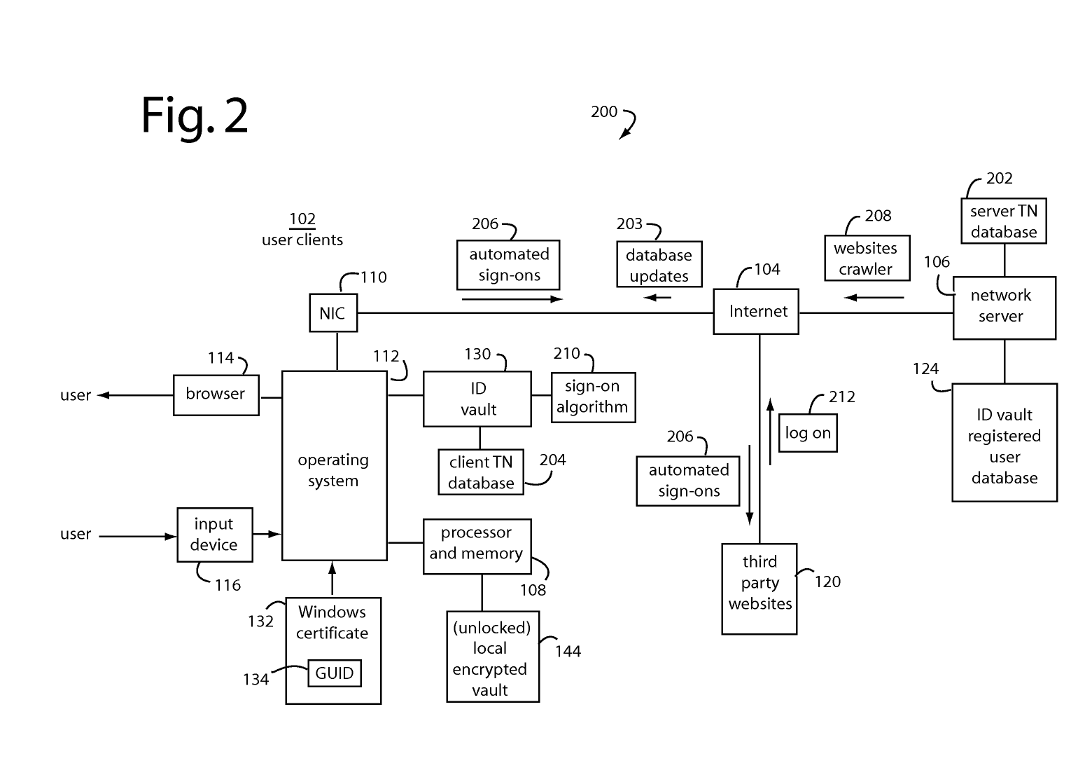

FIG. 2 represents a trusted network library system 200 in an embodiment of the present invention that can be included with the user authentication system 100 of FIGS. 1A-1D. The items in FIG. 2 that are the same as those in FIGS. 1A-1D use the same numbering. Elements of trusted network library system 200 would normally be installed as part of the installation process for ID vault run-time client 130.

The trusted network library system 200 builds a server TN database 202 of trusted third-party websites 120, and is periodically copied in an update 203 to user clients 102 as a client TN database 204. And to control spoofing, client TN database 204 itself is preferably read-only, encrypted, and secure after being installed.

Each entry in server TN database 202 includes a list of websites that are trusted, a description of corresponding sign-on elements and protocols 206 for each website, and any sign-on flags. It could also include websites to avoid. About 8,000 trusted websites would be typical, and these span the range of secure websites that a majority of Internet users would register with and do business.

The Internet 104 and the third-party websites 120 are very fluid and ever changing in the number and qualities of the websites, and so keeping server TN database 202 fresh and up-to-date is an on-going challenge. The construction and testing of server TN database 202 can be automated for the most part, e.g., with a web-site crawler 208. But a professional staff can be needed to guide and support the results obtained so questions can be resolved as to which third-party websites 120 to trust, which are abusive, what protocols to use, and for each, what are the proper mix of sign-on elements. These are collectively embodied in a logical step-by-step procedure executed as a program by processor and memory 108, referred to herein as a sign-on algorithm 210. Each successful use of sign-on algorithm 210 will result in a third-party log-on 212 for the corresponding user client 102.

Keeping the client TN database 204 as up-to-date as possible allows user clients 102 to successfully log-on quickly, it also prevents screen scraping by hiding the sign-on session, and further frustrates attempts at key logging and pharming. Having to download server TN database 202 in real-time every time it is needed is not very practical or desirable. And the connection to network 106 can be dropped or lost without causing interruptions, as long as the local encrypted vault 144 remains unlocked.

The client TN database 204 is preloaded with bundles of data that include, for each of thousands of third-party websites 120, a description of its sign-on elements, IP-data, and sign-on flags. Such data helps the ID vault 130 recognize when the user has navigated to a secure website with the browser 114. The description of sign-on elements describes user name, password, submit buttons, protocols, page fields, etc. The IP-data includes anti-phishing and anti-pharming information. The sign-on flags are used to turn on and turn off special scripts and algorithms 210.

In an alternative embodiment, the whole contents of server TN database 202 are not preloaded into client TN database 204. Only the specific bundle for a particular third party website 120 is downloaded the first time the user navigates browser 114 to the log-on page. Thereafter, the client TN database 204 retains it for repeated visits later. Only if the retained copy fails to work will another download be attempted to fetch an update that may have occurred in server TN database 202.

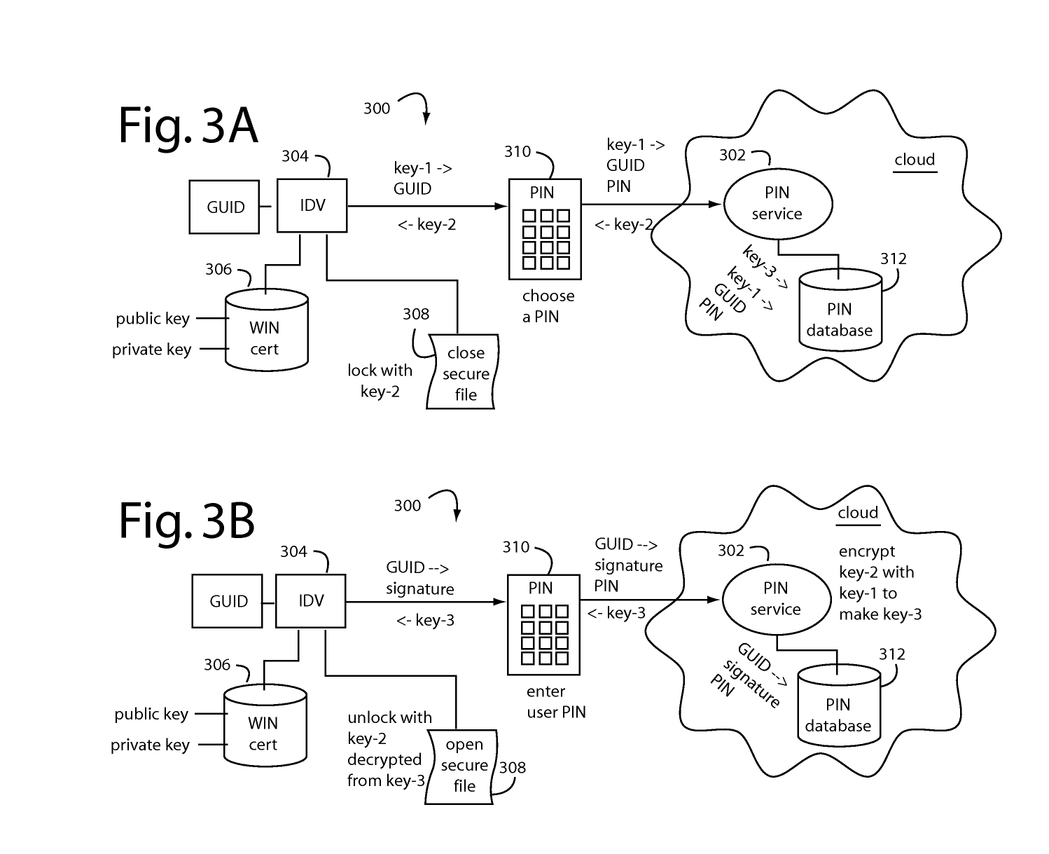

FIGS. 3A and 3B represent a method embodiment of the present invention for user authentication, and is referred to herein by the general reference numeral 300. Method 300 is implemented with computer software that executes on the personal computers and mobile wireless devices of users and at least one network server 302 that includes a PIN service. An ID vault application program 304 is loaded on the user's personal computer or mobile wireless device. It uses public key infrastructure (PKI) encryption to create a single, unique, non-exportable certificate 306 when ID vault application program 304 is installed. A secure file 308 is encrypted with symmetric encryption with a secret key provided by the server 302. The server encrypts the secret key using the public key provided by ID vault application program 304. Then ID vault application program 304 can decrypt it using its private key. The network server 302 will provide those keys only after the user supplies a fresh PIN pad dialog 310 and a check is made to see that non-exportable certificate 306 is correct for this user. Both PIN pad dialog 310 and non-exportable certificate 306 are gathered into a PIN database 312 during an initial registration process for ID vault application program 304. As such, non-exportable certificate 306 (something you have) serves as one of two authentication factors. PIN pad dialog 310 (something you know) serves as the mechanism to input the second authentication factor.

The non-exportable certificate 306 creates a pair of asymmetric encryption keys, one private and one public according to Public Key infrastructure (PKI). In cryptography, a PKI is an arrangement that binds public keys with respective user identities by means of a certificate authority (CA). The user identity is unique within each CA domain. The binding is done during a registration and issuance process. A Registration Authority (RA) assures the binding. The user identity, the public key, their bindings, validity conditions, etc. cannot be faked in public key certificates issued by the CA.

When a user registers ID vault application program 304 for the first time, as in FIG. 3A, each client sends their certificate's public key (key-1), a self-generated GUID, and a PIN they've chosen. The server 302 generates a symmetric key (key-2), and then encrypts key-2 with the supplied key-1, producing a key-3. Key-2 is the actual key for encrypting/decrypting the vault, secure file 308. All the information passed including key-3 are stored in the PIN store database 312. For access to key-2, the certificate's private key is needed to decrypt key-3.

Thereafter, when client 304 has to authenticate a user, as in FIG. 3B, it sends the GUID, a signature of the GUID using the certificate's private key, and a freshly acquired PIN entered at PIN pad 310. Server 302 makes various the tests described above, and sends back key-3. Key-3 is received by the client 304, decrypted to get key-2, and at that point the vault secure file 308 can be accessed using key-2. Only a machine holding the correct certificate can decrypt key-3 because the key-3 was created by using the certificate's public key.

ID vault application program 304 passes its public key for non-exportable certificate 306 to network server 302, e.g., a key-1. The network server 302 uses a symmetric encryption process with a “secret key”, key-2, to encrypt key-1. This produces a key-3 that is stored in PIN database 312. The PIN database 312 is secure from attack because the attackers would need to have access to PIN database 312 and key-1, for every user. Key-2 is returned to ID vault application program 304 so that it can create or unlock encrypted file 308. The key-2 held by ID vault application program 304 is destroyed after it has served its purpose. A new key-2 will therefore be requested to be supplied from network server 302 the next time encrypted file 308 needs to be unlocked. That request will require a fresh entry of PIN pad dialog 310 and an asymmetrically encrypted signature from non-exportable certificate 306. Such signature can include a GUID. The number of failed attempts to authenticate the user and their computer to the server are limited.

A particular vulnerability can occur in the systems illustrated in FIGS. 1A-1D, 2, 3A, and 3B, such as in operating system 112. ID Vault 130, for example, depends on the operating system 112 to securely forward user ID's and passwords 150, and automated sign-ons 206, to network server 106. But malware infecting operating system 112 can highjack the basic system input and output mechanisms, especially if they use Microsoft WINDOWS type import address tables (IAT) and dynamic linked libraries (DLL's).

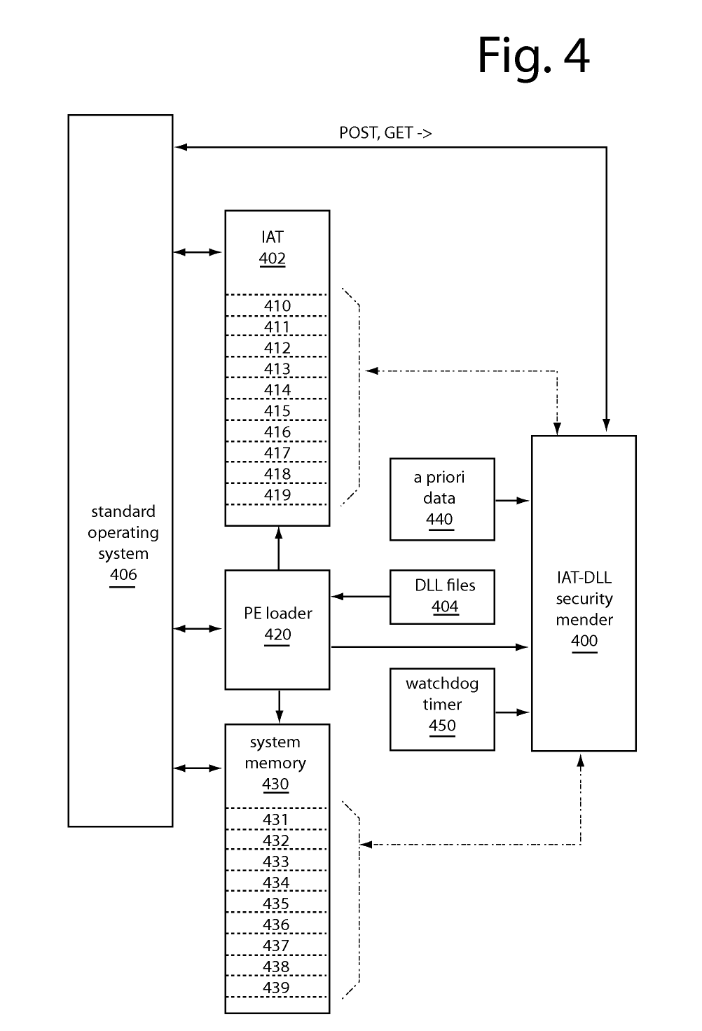

FIG. 4 represents an IAT-DLL security mender in an embodiment of the present invention, and is referred to herein by the general reference numeral 400. IAT-DLL security mender 400 has access to the IAT 402 and DLL files 404 in a standard operating system 406. IAT 402 comprises a table of individual program address pointers 410-419. Initially, these program address pointers 410-419 are null and are computed and set by a PE loader 420 whenever a DLL file 404 is loaded by the operating system into a system memory 430. Each of several executable files 431-419 has absolute addresses assigned during run-time, and pointers to these are fixed as one or more of address pointers 410-419 in IAT 402 by PE loader 420.

IAT-DLL security mender 400 monitors and repairs a limited number of the executable files 431-419 in system memory 430 and the address pointers 410-419 in IAT 402. IAT-DLL security mender 400 has a priori knowledge of the correct values for selected executable files 431-419 and address pointers 410-419. Such is typically provided in an a priori data file 440.

A watchdog timer 450 or PE loader 420, or both, trigger IAT-DLL security mender 400 into action. The a priori data file 440 is consulted for which executable files 431-419 and address pointers 410-419 to write, and what to write them with. Alternatively, the executable files 431-419 and address pointers 410-419 can be consulted for their virgin values when PE loader 420 supplies a trigger indicating that it has acted. The consulted values are stored by IAT-DLL security mender 400 for use later in mending operations. Parts of the a priori data file 440 could be computed by IAT-DLL security mender 400 from the DLL files 404 before their being loaded into system memory 430. The IAT-DLL security mender 400 and a priori data file 440 can themselves be generated and installed by a DLL file 404, especially one bundled with a user-credentials application DLL as in FIGS. 1A-1D, 2, 3A, and 3B.

In one alternative mode of operation, IAT-DLL security mender 400 launches every time sensitive data is about to be sent to a secure webserver. But running IAT-DLL security mender 400 on every HTTP GET or POST operation when logging on to an https-server can inject delays that may be objectionable. The POST request method is used when a client sends data to the server as part of a request, e.g., when uploading a file or submitting a completed form. The GET request method sends only a URL and headers to the server. In contrast, POST requests include a message body. So POST requests allow any type of arbitrary length data to be sent to the server.

In commercial products installed on preexisting computer and operating systems 406, at least one of DLL files 404 can be bundled for sale with IAT-DLL security mender 400 and a priori data 440.

FIGS. 1A-1D, 2, 3A, and 3B, should be considered herein to include IAT-DLL security mender 400, e.g., within operating system 112 (FIGS. 1A-1D and 2) and/or ID vault application program 304 (FIGS. 3A-3B). IAT-DLL security mender 400 would also be beneficial if installed in other similar systems.

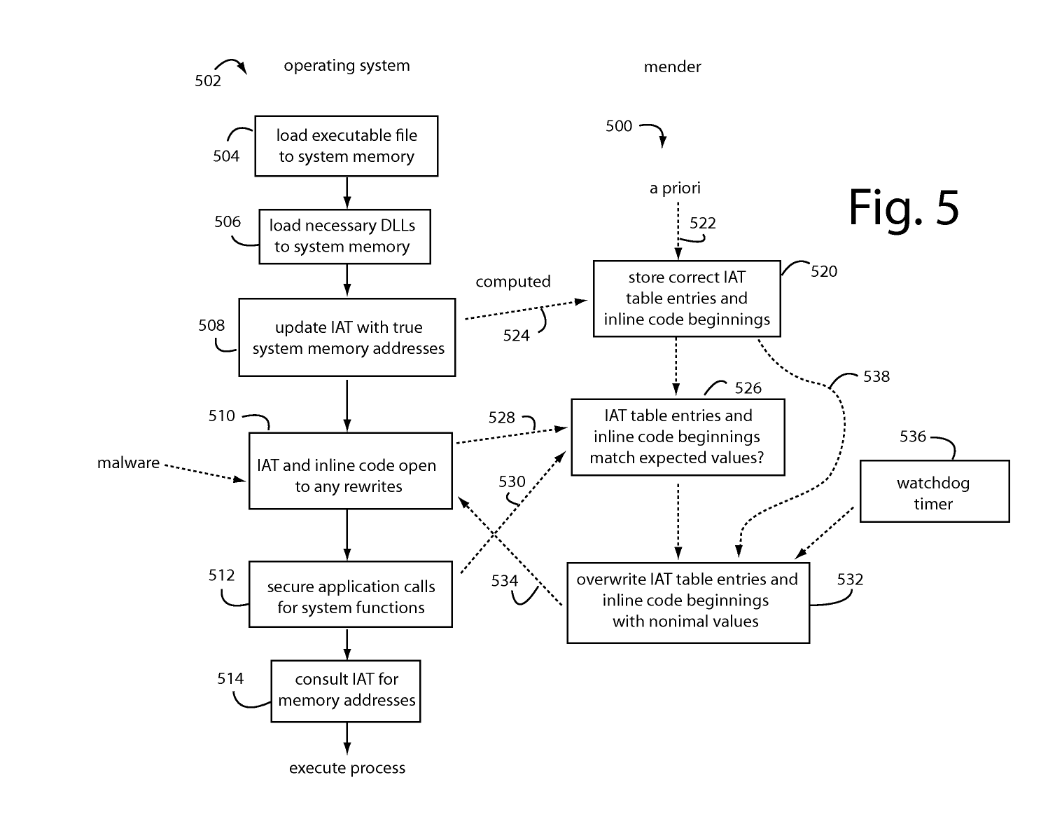

FIG. 5 represents an IAT-DLL security mender process embodiment of the present invention implemented as software and executed by conventional computer platforms. An IAT-DLL security mender 500 is associated with an operating system 502 like Microsoft WINDOWS. The operating system 502 includes a process 504 to load executable files into system memory, and a process 506 to read those files and load any DLLs that will be needed. A process 508 updates an import address table (IAT) with pointers to the real system memory addresses. A process 510 represent the open nature of the IAT and inline code, and their vulnerabilities to malware.

A secure application that needs protection from IAT and inline hooking calls for system functions implemented by the executable files and DLLs in a process 512. The secure application consults the IAT for the real memory addresses in a process 514 and executes.

IAT-DLL security mender 500 runs in parallel and has access to the IAT and inline code in system memory. A process 520 stores the correct IAT table entries and in-process binary images, either from a priori data 522 or from computed values 524. A process 526 fetches particular IAT table entries and in-process binary images for comparison with what they should be. A link 528 provides current values. If the values are other than expected, the system administrator can be alerted to the possibility of malware activity. Process 526 can be triggered to execute by a link 530 whenever the secure application calls for system functions.

A process 532 overwrites particular and sensitive IAT table entries and/or in-process binary images. A link 534 provides access. Alternatively, a watchdog time 536 s used to decide when process 532 should operate.

In alternative embodiments of the present invention, IAT-DLL security mender 500 skips process 526 and just proceeds directly from process 520 to process 532 on a link 538.

Secure Sockets Layer (SSL) protocol is used to manage message transmission security on the Internet, and has lately been superseded by Transport Layer Security (TLS). SSL uses a program layer between the hypertext transfer protocol (HTTP) and transport control protocol (TCP) layers. Standard Microsoft, Netscape, and other browsers include SSL and TLS. A sockets method of passing data back and forth is used between a client and a server program in a network or between program layers in the same computer. SSL may use the public-and-private key encryption system from RSA, which can include the use of a digital certificate. If a website is on a server that supports SSL, SSL can be enabled and specific Web pages can be identified as requiring SSL access.

A security mender process embodiment of the present invention can implemented as software and configured for execution by a conventional computer platform and an operating system. Typical operating systems include sub-processes to load executable files into system memory, to read those files and to load any dynamic linked libraries (DLLs) that will be needed, to update an import address table (IAT) with pointers to real system memory addresses. But these applications vulnerable to malware hooking, because secure applications must consult the IAT for the real memory addresses in order to execute them.

The security mender process comprises a first process configured to store nominal IAT table entries and in-process binary images, from either a priori data and/or from computed values; a second process configured for fetching particular IAT table entries and in-process binary images for comparison with expected values; and, a third process configured to overwrite particular IAT table entries and/or in-process binary images with nominal IAT table entries and in-process binary images. The security mender functions in parallel with the operating system and has access to its IAT and inline code in system memory.

In some embodiments, the security mender is activated for only those application program interface (API) functional calls that relate to sensitive data. Examples of the kinds of sensitive data that would be appropriate to protect are personally identifiable information (PII), protected personal information (PPI) data, and in particular, user-authentication credentials, passwords, PIN-numbers, challenge answers, and others. These are very vulnerable in typical user computers during the operating system's outbound Internet transmission of them by hypertext transfer protocol (HTTP). Particular API functional calls that relate to sensitive data transmission can additionally be protected by secure sockets layer (SLL) or transport layer security (TLS) in subsequent API-function calls.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A security mender process implemented as software and configured for execution by a computer platform and an operating system, wherein the operating system includes a process to load executable files into system memory, a process to read those files and load any dynamic linked libraries (DLLs) that will be needed, a process to update an import address table (IAT) with pointers to real system memory addresses, and applications vulnerable to malware hooking, wherein secure applications must consult the IAT for the real memory addresses in order to execute them, the security mender process comprising:
a process configured to store nominal IAT table entries and in-process binary images, from either a priori data and/or from computed values;
a process configured for fetching particular IAT table entries and in-process binary images for comparison with expected values;
a process configured to overwrite particular IAT table entries and/or in-process binary images with nominal IAT table entries and in-process binary images;
wherein, the security mender functions in parallel with the operating system and has access to its IAT and inline code in system memory.

2. The security mender process of claim 1, further comprising:
a process to alert a system administrator if the values fetched from the IAT or in-process binary images are other than were known to have been previously written.

3. The security mender process of claim 1, further comprising:
a trigger generated whenever the secure application calls for system functions, and that causes the process configured to overwrite particular IAT table entries and/or in-process binary images to install nominal IAT table entries and in-process binary images.

4. The security mender process of claim 1, further comprising:
a watchdog timer for triggering the process configured to overwrite particular IAT table entries and/or in-process binary images to periodically install nominal IAT table entries and in-process binary images.

5. A method for authenticating user client computers to servers, wherein the user has a computer an operating system and network interface that depends on portable executable (PE) files and import address tables (IATs), comprising:
a root certificate attached to the operating system;
a globally unique identifier (GUID) disposed within the root certificate;
a local encrypted vault file for storing user ID's and passwords corresponding to third-party websites, and that is normally locked;
an ID vault computer control program attached to the operating system and for execution by the processor and memory, wherein, when a browser is used to navigate to a third-party website that requires a user ID and password, it automatically requests a decryption key for the local encrypted vault file from a network server by supplying a personal identification number (PIN) from the user through an input device, a copy of the GUID, and a signature of GUID using a private key for the root certificate, and if said decryption key is returned from said network server, the local encrypted vault file is unlocked and automatically supplies a corresponding user ID and password to log-on to the third-party website without the user;
a process configured to store nominal IAT table entries and in-process binary images, from either a priori data and/or from computed values;
a process for fetching particular IAT table entries and in-process binary images for comparison with expected values; and
a process configured to overwrite particular IAT table entries and/or in-process binary images with nominal IAT table entries and in-process binary images;
wherein, the IAT-DLL security mender runs in parallel with the operating system and has access to its IAT and inline code in system memory.

6. The method for authenticating user client computers to servers of claim 5, further comprising:
a process to alert a system administrator if the values fetched from the IAT or in-process binary images are other than expected.

7. The method for authenticating user client computers to servers of claim 5, further comprising:
a trigger generated whenever the secure application calls for system functions, and that causes the process configured to overwrite particular IAT table entries and/or in-process binary images to install nominal IAT table entries and in-process binary images; and
a watchdog timer for triggering the process configured to overwrite particular IAT table entries and/or in-process binary images to periodically install nominal IAT table entries and in-process binary images.

8. An improved method for authenticating users to servers, wherein the user has a computer an operating system that depends on portable executable (PE) files and import address tables (IATs), comprising:
accepting a personal identification number (PIN) into a client computer that will thereafter be used as a first authentication factor to a network server;
generating a globally unique identifier (GUID) only once with said client computer, and digitally encrypting it with an asymmetric encryption algorithm that uses a public key and a private key, wherein the encrypted GUID is digitally stored in said client computer and is thereafter used as a second authentication factor to said network server;
authenticating a user to said network server by forwarding a PIN input collected and said encrypted GUID and said public key to said network client;
returning a secret key from said network server to said client computer if said PIN input collected and encrypted GUID pass a test;
unlocking a local, symmetrically encrypted file with said secret key, wherein the contents are then accessible for use by said client computer;
a process configured to store nominal IAT table entries and in-process binary images, from either a priori data and/or from computed values;
a process for fetching particular IAT table entries and in-process binary images for comparison with expected values; and
a process configured to overwrite particular IAT table entries and/or in-process binary images with nominal IAT table entries and in-process binary images;
wherein, the IAT-DLL security mender runs in parallel with the operating system and has access to its IAT and inline code in system memory.

9. The security mender process of claim 1 is limited to only those application program interface (API) functional calls that relate to sensitive data.

10. The security mender process of claim 9 wherein those API functional calls that relate to sensitive data transmission are additionally protected by secure sockets layer (SLL) or transport layer security (TLS) in subsequent API-function calls.

11. The security mender process of claim 9 wherein the sensitive data being protected comprises user-authentication credentials.
